(19) United States
(12) Patent Application Publication
(10) Pub. No.: US 2007/0299928 A1
(43) Pub. Date: Dec. 27, 2007

(54) MAINTAINING SESSIONS USING COOKIE UPDATION

(76) Inventors: Pooja Kohli, Raleigh, NC (US); Paul F. McMahan, Apex, NC (US)

Correspondence Address: HOFFMAN WARNICK & DALESSANDRO LLC, 75 STATE ST, 14TH FLOOR, ALBANY, NY, 12207, US

(21) Appl. No.: 11/425,738

(22) Filed: Jun. 22, 2006

(51) Int. Cl. G06F 15/16

(52) U.S. Cl. 709/217

(57) ABSTRACT

The present invention provides a methodology for maintaining user sessions using cookie updation. A method in accordance with an embodiment of the present invention includes: periodically updating a value in a session cookie using a program implemented in a source code of a web page; stopping the updating of the value when a user navigates away from the web page; and automatically logging the user out of the web page if the value is determined to be invalid by a web server.

### BACKGROUND OF THE INVENTION

1. Field of the Invention

The present invention generally relates to Internet security, and more specifically relates to a methodology for maintaining and tracking user sessions using cookie updation.

2. Related Art

A secure service such as online banking needs to log a user off as soon as the user navigates away from the service's secure web site. For example, when a user is logged on to a bank's secure web site and then navigates in the same browser window to another web site, the bank's web server should log the user off from the current session as the user is no longer on the secure web site, and has moved to another domain.

A user can log out, for example, by actuating a log out mechanism on the secure web site. Alternatively, or in addition, the web server can maintain some type of timeout counter, and can invalidate the user's session once the timeout period has expired. With one or both of these schemes in place, suppose for some reason the user does not log out explicitly (e.g., using a log out button), navigates away from the secure web site to other web sites on the Internet, and then physically leaves the computer with the web browser window open. Then, if another person sits at the same computer and actuates the back button on the web browser before a session timeout has occurred, that person can access the secure web site, since the original user did not log out. As such, neither timeouts nor logouts suffice in this case.

In many implementations, including some Ajax (Asynchronous JavaScript and XML) type systems, sometimes only the portion of the web page the user is interacting with is refreshed by the web server, instead of the entire web page. The user session might be maintained by the generation of HyperText Transfer Protocol (HTTP) GET requests. The user might get logged off if he is interacting with a portion of the web page or web site that does not generate HTTP Get requests back to the web server. As a result, the web server may start incrementing an inactivity counter for the user and may eventually expire the session, thinking that the user is no longer on the web site. As a result, the web server incorrectly logs an active user from the session.

The general problem is how to keep a user logged on to a web site while the web page is still active in the web browser. The flip side of this problem is how to immediately log out a user who has navigated away from a web page. Known solutions include: user initiated logouts; implementing a heartbeat to inform the web server that the web page is still active; and timeouts and activity counters.

User initiated logouts are used to inform the web server to close the current session. This is dependent on a human action, and will fail if the user does not manually actuate the logout mechanism. Heartbeats work by constantly communicating with the web server to let the web server know that a user is still logged in. Although this will result in correct sessions being maintained, it also generates excessive network traffic as well as constant processing on the web server side. Heartbeating also is not easily implementable as it poses serious scalability issues. Timeouts are initiated by the web server. Timeouts will fail if a user hijacks the session within the timeout window. A short timeout interval may result in a user being logged out prematurely, while a longer timeout may result in a security problem such as that discussed above. In some Ajax type systems, inactivity counters will incorrectly logout a user.

Accordingly, a need exists for a solution for logging out a user when the user navigates away from a web site, and for maintaining the session of the user while the user remains on the web site, that does not suffer from these and other deficiencies of the prior art.

### SUMMARY OF THE INVENTION

The present invention provides a methodology for maintaining user sessions using cookie updation. In accordance with the present invention, a session cookie is periodically updated with a value through a JavaScript (Java and all Java-based trademarks are trademarks of Sun Microsystems, Inc. in the United States, other countries, or both) implemented in the source code of a web page. As soon as a user navigates away from the web page, the session cookie will no longer will be updated. When the web server determines that the last updated value in the session cookie is not what it expected it to be, the web server will log out the user and require the user to log in again. However, as long as the web page is in the web browser, the session cookie will be updated, so a user who has not been generating a lot of requests back to the web server can still maintain a live session. This is useful for those types of systems where there can be infrequent interaction between the web page and the web server.

A first aspect of the present invention is directed to a method for maintaining a session, comprising: periodically updating a value in a session cookie using a program implemented in a source code of a web page; stopping the updating of the value when a user navigates away from the web page; and automatically logging the user out of the web page if the value is determined to be invalid.

A second aspect of the present invention is directed to a method for maintaining a session, comprising: sending source code for a web page from a web server to a web browser on a client device, the source code including a program for periodically updating a value; examining the value at the web server; and automatically logging a user out of the web page if the web server determines that the value is invalid.

A third aspect of the present invention is directed to a system for maintaining a session, comprising: a system for periodically updating a value in a session cookie using a program implemented in a source code of a web page; a system for stopping the updating of the value when a user navigates away from the web page; and a system for automatically logging the user out of the web page if the value is determined to be invalid.

A fourth aspect of the present invention is directed to a program product stored on a computer readable medium for maintaining a session, the computer readable medium comprising program code for: periodically updating a value in a session cookie using a program implemented in a source code of a web page; stopping the updating of the value when a user navigates away from the web page; and automatically logging the user out of the web page if the value is determined to be invalid.

A fifth aspect of the present invention is directed to a method for deploying an application for maintaining a session, comprising: providing a computer infrastructure being operable to: periodically update a value in a session cookie using a program implemented in a source code of a web page; stop the updating of the value when a user navigates away from the web page; and automatically log the user out of the web page if the value is determined to be invalid.

The illustrative aspects of the present invention are designed to solve the problems herein described and other problems not discussed

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative system for cookie updation in accordance with an embodiment of the present invention.

FIG. 2 depicts a general flow diagram of an illustrative process for cookie updation in accordance with an embodiment of the present invention.

FIG. 3 depicts an illustrative computer system for implementing embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

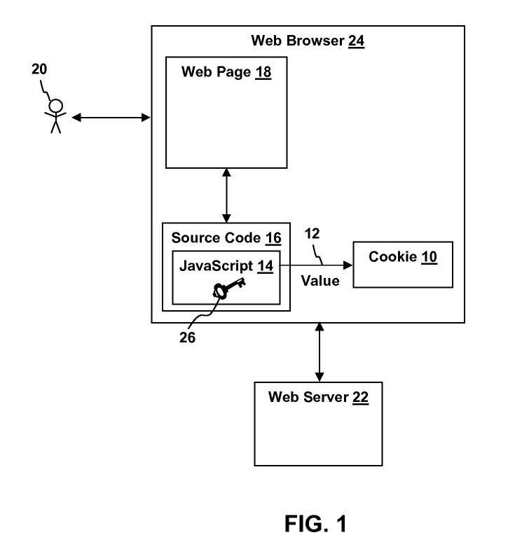

The present invention provides a methodology for maintaining user sessions using cookie updation. In accordance with the present invention, as schematically depicted in FIG. 1, a session cookie 10 is periodically updated with a value 12 through a JavaScript 14 (or other suitable code) implemented in the source code 16 of a web page 18. As soon as a user 20 navigates away from the web page 18, the session cookie 10 will no longer will be updated. When the web server 22 determines that the last updated value in the session cookie 10 is not what it expected it to be, the web server 22 will log out the user 20 and require the user 20 to log in again. However, as long as the web page 18 is in the web browser 24, the session cookie 10 will be updated, so a user who has not been generating a lot of requests back to the web server 22 can still maintain a live session.

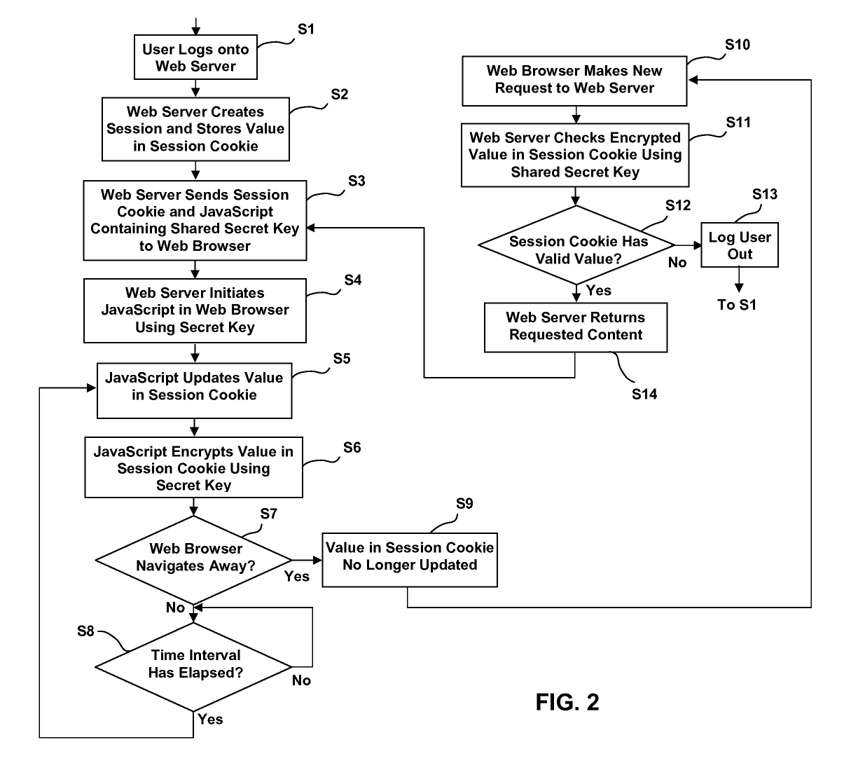

FIG. 2 depicts a general flow diagram of an illustrative process for cookie updation in accordance with an embodiment of the present invention. The process of FIG. 2 is described below with regard to the components of the cookie updation system illustrated in FIG. 1.

In step S1, the user 20 logs onto the web server 22 via a web browser 24. In response, in step S2, the web server 22 creates a session for the user 20 and stores an initial value 12 in the session cookie 10. The value 12 can comprise a timestamp or any other type of value that can be interpreted by the web server 22 as representing either a valid or invalid session. The session cookie 10 and the JavaScript 14 containing a shared secret key 26 are sent by the web server 22 to the web browser 24 in step S3. The JavaScript 14, when first launched by the web browser 24, is initiated with the shared secret key 26 by the web server 22 in step S4. Preferably, the web server 22 requests that the JavaScript 14 not be cached by the web browser 24 by returning an HTTP No Cache Call to the web browser 24. To this extent, since the JavaScript 14 is not cached, a new shared secret key 26 is initiated each time the user 20 is made to log-in again by the web server 22.

The value 12 in the session cookie 10 is periodically updated (e.g., every 1 second) by the JavaScript 14 in step S5. Thereafter, in step S6, the value 12 in the session cookie 10 is encrypted by the JavaScript 14 using the shared secret key 26. Flow then passes to step S7.

If it is determined in step S7 that the user 20 has not navigated the web browser 24 away from the web page 18, then flow passes to step S8. Otherwise flow passes to step S9. In step S8, if it is determined that the time interval for the periodic updating of the value 12 has elapsed, then flow returns to step S5, where the value 12 in the session cookie 10 is updated by the JavaScript 14. If not, step S8 is repeated until the time interval for the periodic updating of the value 12 has elapsed. At that point, flow returns to step S5, where the value 12 in the session cookie 10 is updated by the JavaScript 14.

If it is determined in step S7 that the user 20 has navigated the web browser 24 away from the web page 18, then the value 12 in the session cookie 10 is no longer updated by the JavaScript 14 as indicated in step S9. The web browser 24 makes a new request for different content (e.g., a different web page) to the web server 22 in step S10. In response, in step S11, the web server 22 checks whether the encrypted value 12 in the session cookie 10 is valid using the shared secret key 26. If the encrypted value 12 is not valid (step S12), the user 20 is logged out in step S13 and flow passes back to step S1, where the user 20 is requested to log in again by the web server 22 in order to access the web page 18. If the encrypted value 12 is found to be valid (step S12), the web server 22 returns the requested content in step S14 and flow returns to step S3.

In accordance with the present invention, the updating of the value 12 in the session cookie 10 by the JavaScript 14 is performed on the client side (i.e., by the web browser 24) rather than on the server side (i.e., by the web server 22). This obviates problems such as scalability and excess network traffic associated with heartbeating. Further, unlike with inactivity counters and the like, the user 20 is not logged out incorrectly on a system (e.g., on some Ajax type systems) where the user 20 is not constantly interacting with the web server 22. Additionally, as soon as the user 20 navigates away from the web page 18 the session cookie 10 will not be updated and the user's session will be invalidated. To this extent, the user's session does not depend on timeout periods and/or on the user 20 manually performing the logout.

As stated above, the value 12 in the session cookie 10 can comprise a timestamp. As such, the present invention also has value in a advertising/tracking model. For example, advertisers, companies, and other marketing entities can use the timestamp to determine how long a particular user has been logged onto particular web sites, the interests of the user, and other useful information.

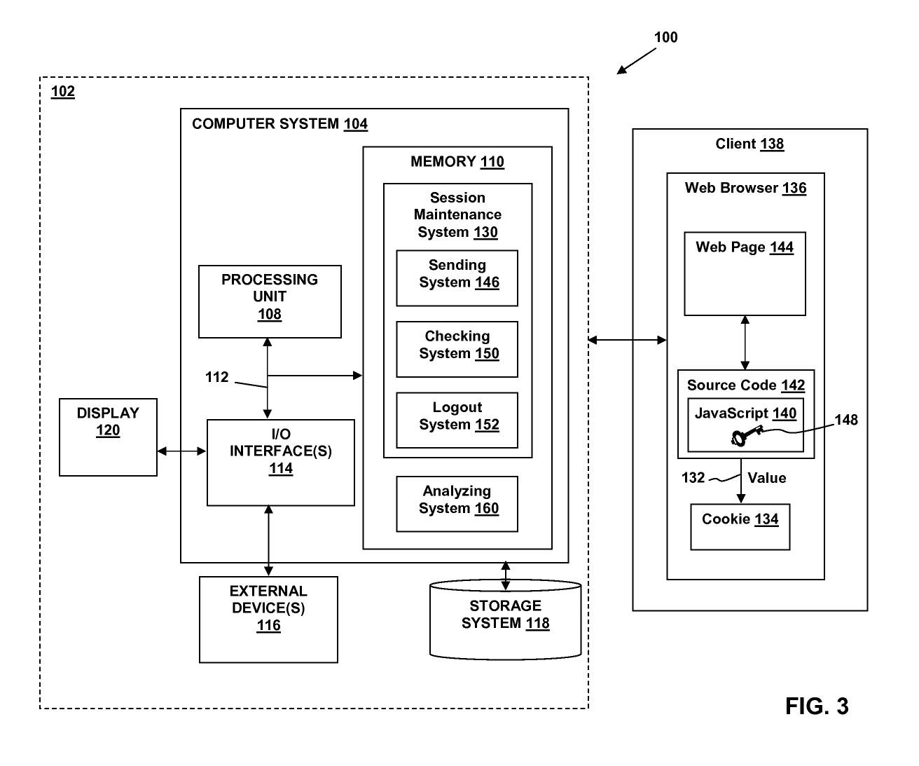

FIG. 3 shows an illustrative system 100 in accordance with embodiment(s) of the present invention. The system 100 includes a computer infrastructure 102 that can perform the various process steps described herein. In particular, the computer infrastructure 102 is shown including a computer system 104 (i.e., a web server) that comprises a session maintenance system 130 for maintaining user sessions based on a value 132 (e.g., a timestamp) in a session cookie 134 provided by a web browser 136 running on a client device 138. A JavaScript 140 implemented in the source code 142 of a web page 144 in the web browser 136 periodically updates the value 132 in the session cookie 134.

The computer system 104 is shown as including a processing unit 108, a memory 110, at least one input/output (I/O) interface 114, and a bus 112. Further, the computer system 104 is shown in communication with at least one external device 116 and a storage system 118. In general, the processing unit 108 executes computer program code, such as the session maintenance system 130, that is stored in memory 110 and/or storage system 118. While executing computer program code, the processing unit 108 can read and/or write data from/to the memory 110, storage system 118, and/or I/O interface(s) 114. Bus 112 provides a communication link between each of the components in the computer system 104. The external device(s) 116 can comprise any device (e.g., display 120) that enables a user (not shown) to interact with the computer system 104 or any device that enables the computer system 104 to communicate with one or more other computer systems. The client device 138 can include a similar configuration of components.

In any event, the computer system 104 can comprise any general purpose computing article of manufacture capable of executing computer program code installed by a user (e.g., a personal computer, server, handheld device, etc.). However, it is understood that the computer system 104 and the session maintenance system 130 are only representative of various possible computer systems that may perform the various process steps of the invention. To this extent, in other embodiments, the computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, the computer infrastructure 102 is only illustrative of various types of computer infrastructures that can be used to implement the present invention. For example, in one embodiment, the computer infrastructure 102 comprises two or more computer systems (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computer systems may utilize any combination of various types of transmission techniques.

The session maintenance system 130 includes a sending system 146 for sending the session cookie 134 and the JavaScript 140 (which contains a shared secret key 148) to the web browser 136. The session maintenance system 130 further includes a checking system 150 and a logout system 152. The checking system 150 receives and checks the value 132 in the session cookie 134 and, if the value 132 is not valid, the logout system 152 logs the user off of the web page 144. An analyzing system 160 can also be provided to determine how long a particular user has been logged onto a particular web site (e.g., if the value 132 in the session cookie 134 comprises a timestamp), the interests of the user, and other information. The operation(s) carried out by each of these systems is discussed above. It is understood that some of the various systems shown in FIG. 3 can be implemented independently, combined, and/or stored in memory for one or more separate computer systems that communicate over a network. Further, it is understood that some of the systems and/or functionality may not be implemented, or additional systems and/or functionality may be included as part of the system 100.

While shown and described herein as a method and system for maintaining user sessions using cookie updation, it is understood that the invention further provides various alternative embodiments. For example, in one embodiment, the invention provides a computer-readable medium that includes computer program code to enable a computer infrastructure to maintain user sessions using cookie updation. To this extent, the computer-readable medium includes program code, which implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computer system, such as the memory 110 and/or storage system 118 (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider could offer to maintain user sessions using cookie updation in accordance with the present invention. In this case, the service provider can create, maintain, support, etc., a computer infrastructure, such as the computer infrastructure 102, that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method for maintaining user sessions using cookie updation. In this case, a computer infrastructure, such as the computer infrastructure 102, can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of (1) installing program code on a computer system, such as the computer system 104, from a computer-readable medium; (2) adding one or more computer systems to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computer system having an information processing capability to perform a particular function either directly or after either or both of the following: (a) conversion to another language, code or notation; and (b) reproduction in a different material form. To this extent, program code can be embodied as one or more types of program products, such as an application/software program, component software/a library of functions, an operating system, a basic I/O system/driver for a particular computing and/or I/O device, and the like.

The foregoing description of the preferred embodiments of this invention has been presented for purposes of illustration and description. It is not intended to be exhaustive or to limit the invention to the precise form disclosed, and obviously, many modifications and variations are possible.

What is claimed is:

1. A method for maintaining a session, comprising:
periodically updating a value in a session cookie using a program implemented in a source code of a web page;
stopping the updating of the value when a user navigates away from the web page; and
automatically logging the user out of the web page if the value is determined to be invalid.

2. The method of claim 1, wherein the program comprises a JavaScript.

3. The method of claim 1, further comprising:
continuing the updating of the value as long as the user does not navigate away from the web page.

4. The method of claim 1, further comprising:
examining the value at a web server; and
automatically logging the user out of the web page if the web server determines that the value is invalid.

5. The method of claim 1, wherein the value comprises a timestamp.

6. The method of claim 5, further comprising:
analyzing the timestamp to determine how long a user has been viewing the web page.

7. The method of claim 1, further comprising:
encrypting the session cookie.

8. The method of claim 6, wherein the encrypting further comprises:
receiving a key with the program from a web server; and
encrypting the session cookie using the key.

9. A method for maintaining a session, comprising:
sending source code for a web page from a web server to a web browser on a client device, the source code including a program for periodically updating a value;
examining the value at the web server; and
automatically logging a user out of the web page if the web server determines that the value is invalid.

10. A system for maintaining a session, comprising:
a system for periodically updating a value in a session cookie using a program implemented in a source code of a web page;
a system for stopping the updating of the value when a user navigates away from the web page; and
a system for automatically logging the user out of the web page if the value is determined to be invalid.

11. The system of claim 10, wherein the program comprises a JavaScript.

12. The system of claim 10, wherein the system for periodically updating continues to update the value as long as the user does not navigate away from the web page.

13. The system of claim 10, further comprising:
a system for examining the value at a web server; and
a system for automatically logging the user out of the web page if the web server determines that the value is invalid.

14. The system of claim 10, wherein the value comprises a timestamp.

15. The system of claim 14, further comprising:
a system for analyzing the timestamp to determine how long a user has been viewing the web page.

16. The system of claim 10, further comprising:
a system for encrypting the session cookie.

17. The system of claim 16, wherein the system for encrypting further comprises:
a system for receiving a key with the program from a web server; and
a system for encrypting the session cookie using the key.

18. A program product stored on a computer readable medium for maintaining a session, the computer readable medium comprising program code for:
periodically updating a value in a session cookie using a program implemented in a source code of a web page;
stopping the updating of the value when a user navigates away from the web page; and
automatically logging the user out of the web page if the value is determined to be invalid.

19. The program product of claim 18, further comprising program code for:
examining the value at a web server; and
automatically logging the user out of the web page if the web server determines that the value is invalid.

20. The program product of claim 18, wherein the value comprises a timestamp.

21. The program product of claim 18, further comprising program code for:
receiving a key with the program from a web server; and
encrypting the session cookie using the key.
